(19) United States
(12) Patent Application Publication
(10) Pub. No.: US 2005/0003113 A1
(43) Pub. Date: Jan. 6, 2005

(54) Inkjet recording materials

(76) Inventors: Tienteh Chen, San Diego, CA (US); Richard J. McManus, San Diego, CA (US); Tony Pidding, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/613,495

(22) Filed: Jul. 2, 2003

(51) Int. Cl. B41M 5/00

(52) U.S. Cl. 428/32.18

(57) ABSTRACT

A print medium having improved image quality and permanence. The print medium comprises a coated paperbase and an ink-receiving layer. The ink-receiving layer is present on the coated paperbase at less than approximately 10 grams per square meter. A method of forming the print medium is also disclosed. In addition, a method of printing an image having improved image quality and permanence is disclosed.

### BACKGROUND OF THE INVENTION

Print media that are capable of inkjet printing photographic image quality generally include an ink-receiving layer on a substrate, such as a paperbase or a photobase. The ink-receiving layer includes multiple coatings that are formed from inorganic or organic materials, such as inorganic particles or organic polymers. The print media are typically categorized into two groups: porous media and swellable media. Porous media generally have an ink-receiving layer that is formed from porous, inorganic particles bound with a polymer binder. The inkjet ink is absorbed into the pores of the inorganic particles and the colorant is fixed by mordants incorporated in the ink-receiving layer or by the surface of the inorganic oxides. Porous media have a short dry time and good resistance to smearing because the inkjet ink is easily absorbed into the pores of the ink-receiving layer. However, porous media do not exhibit good resistance to fade. In swellable media, the ink-receiving layer is a continuous layer of a swellable, polymer matrix. When the inkjet ink is applied, the inkjet ink is absorbed by swelling of the polymer matrix and the colorant is immobilized inside the continuous layer. Since the colorant is protected from the outside environment, swellable media have greater resistance to light and dark/air fade than the porous media. However, the swellable media generally have reduced smearfastness and a longer drytime than porous media.

To achieve high image quality, photobase papers have typically been used as the substrate in print media instead of paperbase papers. Photobase papers are pulp papers laminated with a polyethylene layer on each side. While photobase papers provide high image quality, they are more expensive than paperbase papers and add to the overall cost of the print media. Furthermore, photobase papers do not readily absorb the ink vehicle used in the inkjet ink. Therefore, a high coatweight of the ink-receiving layer, such as greater than 25 grams per square meter (“GSM”), is necessary to absorb the ink vehicle. In addition, multiple layers are used as the ink-receiving layer to separate the colorant from the ink vehicle to improve coalescence. Mixtures of water-soluble polymers have also been used to achieve the desired image quality. Another disadvantage of using photobase papers is that the images printed on these print media have poor bleed and color fastness under humid conditions. Therefore, there is need to improve the performance of conventional, non-absorptive photobase papers.

In contrast, images printed on print media having paperbase papers have good bleed resistance. These paperbase papers include uncoated papers (referred to herein as “plain papers”) and papers having coated, porous surfaces that allow the inkjet ink to be readily absorbed and to dry quickly. However, the paperbases tends to cockle and wrinkle when inkjet ink is printed upon it, which decreases the image quality and glossiness of the printed image. In addition, the color gamut or color saturation of the printed image is typically much lower than that of an image printed on photobase paper.

Numerous print media for printing photographic quality images are known in the art. These print media include an ink-receiving layer having a coating composition that includes a hydrophilic polymer, organic or inorganic particles, a cationic polymer, a hardening agent, and a nonionic, anionic, or cationic surfactant. Some of the coating compositions have been used with photobase while others have been used with paperbase. These coating compositions are typically present on the photobase or paperbase at 5 to 40 GSM. However, these print media do not exhibit low levels of mottle, haze, humid bleed, humid color shift, and coalescence. In addition, the print media do not provide optimal levels of optical density (“OD”), color gamut, and lighffastness.

It would be desirable to produce a paper-based print medium having photographic image quality. The print medium is desirably low cost and also provides high print quality, high color gamut, high image permanence, and better humid bleed and humid color shift compared to a print medium having a photobase paper. In addition, the images printed on the print medium should have minimal mottle, haze, humid bleed, and humid color shift. The printed images should also have an excellent optical density (“OD”), color gamut, and lighffastness. The print medium also should desirably have a low coatweight of the ink-receiving layer.

### BRIEF SUMMARY OF THE INVENTION

The present invention relates to a print medium comprising an ink-receiving layer and a coated paperbase. The ink-receiving layer may be present on the coated paperbase at less than approximately 10 GSM. The coated paperbase has a Sheffield smoothness less than approximately 20 and a Sheffield porosity less than approximately 10.

The present invention also relates to a method of forming a print medium having improved image quality and permanence. The method comprises providing a coated paperbase comprising a coated paper, a cast-coated paper, or a commercial offset paper. An ink-receiving layer is applied to the coated paperbase at less than approximately 10 grams per square meter. The coated paperbase has a Sheffield smoothness less than approximately 20 and a Sheffield porosity less than approximately 10.

The present invention also relates to a method of printing an image having improved image quality and permanence. The method comprises providing a print medium that includes a coated paperbase and an ink-receiving layer. The image is printed on the print medium. The ink-receiving layer may be present on the coated paperbase at less than approximately 10 grams per square meter. The coated paperbase has a Sheffield smoothness less than approximately 20 and a Sheffield porosity less than approximately 10.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawing in which:

FIG. 1 schematically illustrates a print medium according to an embodiment of the present invention.

### DETAILED DESCRIPTION OF THE INVENTION

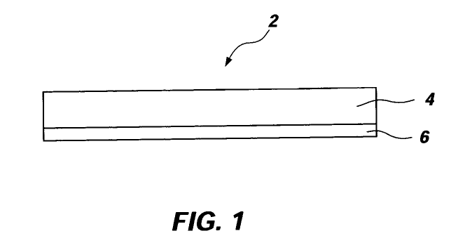

The present invention provides a swellable, print medium that exhibits improved image quality and permanence. The print medium 2 has an ink-receiving layer 4 that is formed over a coated paperbase 6, as illustrated in FIG. 1. The ink-receiving layer 4 may include at least one hydrophilic or water-soluble polymer, a cross-linking agent, a mordant, inorganic particles, and at least one surfactant. A thin layer of the ink-receiving layer 4 may be applied to the coated paperbase 6 to form the print medium 2. Images printed on the print medium 2 have improved mottle, haze, color gamut, K_{od}, lighffastness, humid bleed, and humid color shift.

The water-soluble polymer may be used to provide fast ink absorption and good image quality, to bind the components of the ink-receiving layer 4 together, and to provide physical strength to the print medium 2. The water-soluble polymer may include, but is not limited to, polyvinyl alcohol (“PVOH”), a copolymer of polyvinylalcohol with polyethyleneoxide, a copolymer of polyvinylalcohol with polyacrylic or maleic acid, acetoacetylated polyvinylalcohol, polyvinylalcohol with quaternary ammonium functional groups, a copolymer of polyvinylalcohol-polyvinylamine, polyvinyl pyrrolidone, a copolymer of polyvinylpyrrolidone with polyvinylacetate, polyacrylamide, polyethylene oxide, hydroxyethyl cellulose, hydroxypropylmethyl cellulose, poly(N-ethyl-2-oxazoline), casein, starch, agar, carrageenan, polymethacrylamide, cellulose, carboxymethyl cellulose, dextran, pullulan, gelatin, a derivative thereof, or a mixture thereof. If a mixture of water-soluble polymers is used, the mixture may include more than one compound from one of these classes of water-soluble polymers or more than one compound from more than one of these classes of water-soluble polymers. The water-soluble polymer(s) may be present in the ink-receiving layer 4 from about 60% to about 90% based on the total weight of the ink-receiving layer 4.

In one particular embodiment of the invention, the at least one water-soluble polymer is PVOH, a modified PVOH, or a mixture of PVOH compounds. The modified PVOH may be formed by cationic or anionic modifications to the end of the PVOH molecule. These PVOH compounds are available from numerous sources, such as Kuraray Specialties Europe GmbH (Frankfurt, Germany) and Nippon Gohsei (Osaka, Japan). The PVOH may be partially or completely saponified and has a saponification ratio of from approximately 70% to approximately 100%. More preferably, the saponification ratio is at least approximately 80%. For optimum coalescence, preferably, a mixture of PVOH compounds having 80-88% hydrolysis is used in the ink-receiving layer 4. If the ink-receiving layer 4 includes more than one compound from more than one class of water-soluble polymers, PVOH may be present as a major component of the mixture. In other words, the PVOH may be present in the mixture from approximately 90% to approximately 95%. For instance, the ink-receiving layer 4 may include PVOH and polyvinyl pyrrolidone.

The inorganic particles used in the ink-receiving layer 4 may have a small particle size and a low index of refraction. The inorganic particles may include, but are not limited to, precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo boehmite, aluminum hydroxide, lithopone, zeolite, or magnesium hydroxide. The inorganic particles may have a small diameter, such as from approximately 3 nm to approximately 30 nm. The inorganic particles used in the ink-receiving layer may be positively or negatively charged, which is provided by a modification to the surface of the inorganic particles. Preferably, colloidal silica is used in the ink-receiving layer 4. If colloidal silica is used, the charge may be provided by treating the surface of the colloidal silica particles with aluminum, calcium, magnesium, or barium ions. More preferably, a cationic, superfine colloidal silica is used in the ink-receiving layer 4. Cationic, superfine colloidal silica is commercially available from numerous sources, such as Ludox® CL from Grace Davison (Columbia, Md.).

To provide the print medium 2 with good smudge and water resistance, the cross-linking agent may be used in the ink-receiving layer 4. The cross-linking agent includes a functional group that may react with a functional group on the water-soluble polymer. For instance, when PVOH is used as the water-soluble polymer, the cross-linking agent may include a functional group that reacts with hydroxyl groups on the PVOH. The cross-linking agent may include, but is not limited to, boric acid and salts thereof; an epoxy based agent, such as diglycidyl ethyl ether, ethylene glycol diglycidyl ether, 1,4-butanediol diglycidyl ether, 1,6-diglycidylcyclohexane, N,N-glycidyl-4-glycidyloxyaniline, sorbitol polyglycidyl ether, or glycerol polyglycidyl ether; an aldehyde based agent, such as formaldehyde, glutaric dialdehyde, succinic dialdehyde, or glyoxal; a blocked aldehyde agent, such as Curesan™ 200 from BASF Corp. (Mount Olive, N.J.), Cartabond TSI from Clariant Ltd. (Muttenz, Switzerland), and methylolmelamine; an active halogen based agent, such as 2,4-dichloro4-hydroxy-1,3,5-s-triazine; an active vinyl based compound, such as 1,3,5-trisacryloyl-hexahydro-s-triazine or bisvinylsulfonyl methyl ether; an aluminum alum; an isocyanate compound; or a derivative thereof. The boric acid may include, but is not limited to, orthoboric acid, diboric acid, metaboric acid, tetraboric acid, pentaboric acid, octaboric acid, and salts thereof. Preferably, boric acid is used as the cross-linking agent. The amount of cross-linking agent present in the ink-receiving layer 4 may depend on the type of water-soluble polymer and inorganic particles that are used. It is contemplated that the cross-linking agent may be present from approximately 0.1% to approximately 5% based on the weight of the water-soluble polymer, such as PVOH.

The mordant used in the ink-receiving layer 4 may be a water-soluble compound that does not interact with the water-soluble polymer or the cross-linking agent. In addition, the mordant may not adversely impact the printing process. The mordant may be a cationic polymer, such as a polymer having a primary amino group, a secondary amino group, a tertiary amino group, a quaternary ammonium salt group, or a quaternary phosphonium salt group. The mordant may be in a water-soluble form or in a water-dispersible form, such as in latex. The water-soluble cationic polymer may include, but is not limited to, a polyethyleneimine; a polyallylamine; a polyvinylamine; a dicyandiamide-polyalkylenepolyamine condensate; a polyalkylenepolyamine-dicyandiamideammonium condensate; a dicyandiamide-formalin condensate; an addition polymer of epichlorohydrin-dialkylamine; a polymer of diallyldimethylammoniumchloride (“DADMAC”); a copolymer of diallyldimethylammoniumchloride-SO₂, polyvinylimidazole, polyvinypyrrolidone; a copolymer of vinylimidazole, polyamidine, chitosan, cationized starch, polymers of vinylbenzyltrimethylammoniumchloride, (2-methacryloyloxyethyl)trimethyl-ammoniumchloride, and polymers of dimethylaminoethylmethacrylate; or a polyvinylalcohol with a pendant quaternary ammonium salt. Examples of the water-soluble cationic polymers that are available in latex form and are suitable as mordants are TruDot P-2604, P-2606, P-2608, P-2610, P-2630, and P-2850 (available from MeadWestvaco Corp. (Stamford, Conn.)) and Rhoplex® Primal-26 (available from Rohm and Haas Co. (Philadelphia, Pa.)). It is also contemplated that cationic polymers having a lesser degree of water-solubility may be used in the ink-receiving layer 4 by dissolving them in a water-miscible organic solvent.

A metal salt, such as a salt of an organic or inorganic acid, an organic metal compound, or a metal complex, may also be used as the mordant. For instance, since aluminum salts are inexpensive and provide the desired properties in the ink-receiving layer 4, an aluminum salt may be used. The aluminum salt may include, but is not limited to, aluminum fluoride, hexafluoroaluminate (for example, potassium salts), aluminum chloride, basic aluminum chloride (polyaluminum chloride), tetrachloroaluminate (for example, sodium salts), aluminum bromide, tetrabromoaluminate (for example, potassium salts), aluminum iodide, aluminate (for example, sodium salts, potassium salts, and calcium salts), aluminum chlorate, aluminum perchlorate, aluminum thiocyanate, aluminum sulfate, basic aluminum sulfate, aluminum sulfate potassium (alum), ammonium aluminum sulfate (ammonium alum), sodium sulfate aluminum, aluminum phosphate, aluminum nitrate, aluminum hydrogenphosphate, aluminum carbonate, polyaluminum sulfate silicate, aluminum formate, aluminum diformate, aluminum triformate, aluminum acetate, aluminum lactate, aluminum oxalate, aluminum isopropionate, aluminum butyrate, ethyl acetate aluminum diisopropionate, aluminum tris(acrylacetonate), aluminum tris(ethylacetoacetate), and aluminum monoacetylacetonate-bis(ethylaceto-acetate). Preferably, the mordant is a quaternary ammonium salt, such as a DADMAC derivative; an aluminum salt, such as aluminum triformate or aluminum chloride hydrate; or a cationic latex that includes quaternary ammonium functional groups, like TruDot P-2608. These are available from numerous sources, such as BASF Corp. (Mount Olive, N.J.), Ciba Specialty Chemicals (Basel, Switzerland), and MeadWestvaco Corp. (Stamford, Conn.).

The ink-receiving layer 4 may also include a surfactant, such as an anionic, nonionic, or cationic surfactant. Nonionic surfactants that may be used include, but are not limited to, ethoxylated alkylphenols, ethoxylated fatty acids and esters, ethoxylated alcohols, an alkoxlyated tetramethyl decyndiol, an alkoxylated trimethylnonanol, a polyoxyethylene ether, and an ethylene oxide/propylene oxide copolymer. Anionic surfactants that may be used include, but are not limited to, alkylaryl sulfonates, diphenylsulfonate derivatives, olefin sulfonates, phosphate esters, sulfates and sulfonates of oils and fatty acids, sulfates or sulfonates of fluorosurfactants, sulfates and sulfonates of ethoxylated alkylphenols, sulfates of alcohols, sulfates of ethoxylated alcohols, sulfates of fatty esters, sulfonates of condensed naphthalenes, sulfonates of dodecyl and tridecylbenzenes, sulfonates of naphthalene and alkyl naphthalene. Examples of cationic surfactants that may be used include, but are not limited to, surfactants having quaternary ammonium salts and phosphonium salts. Preferably, the surfactant is a nonionic organosilicone compound, such as a copolymer of polysiloxane-polyethylene oxide or terpolymer of polysiloxane-polyethylene oxide-poly(propylene oxide), and ethylene oxide/propylene oxide diblock and triblock copolymers. Nonionic siloxane surfactants may be obtained from OSI Specialties (South Charleston, W. Va.) under the tradename Silwet®. Ethylene oxide/propylene oxide diblock and triblock copolymers may be obtained from BASF Corp. under the tradenames Pluronic® F, Pluronic® L, Pluronic® P, Pluronic® R, Tetronic®, or Tetronic® R. Preferably, the nonionic, organosilicone surfactant is a Silwet® compound, such as Silwet® L-7201 or Silwet® L-7605.

While the Examples below describe coating compositions of the ink-receiving layer 4 as having one mordant, cross-linking agent, inorganic particles, and organosilicone surfactant, it is understood that the ink-receiving layer 4 may include more than one of each of these components. For instance, the ink-receiving layer 4 may include a mixture of mordants, a mixture of cross-linking agents, or a mixture of organosilicone surfactants.

The coated paperbase 6, which is formed by conventional techniques, may be absorptive so that it is capable of absorbing water and humectants present in the ink vehicle. The coated paperbase 6 may include a coated paper (such as a calendared paper or an uncalendared paper), a cast-coated paper, or a commercial offset paper. As used herein, a coated paper is a paper having a surface coating of a minimum weight that has been applied to improve the paper's appearance and printability. For instance, the coated paper may have a coating weight equal to or greater than 2.5 lbs (3.75 g/m²) per side for papers less than 50 lbs (75 g/m²) in total basis weight or equal to or greater than 4.0 lbs (6 g/m²) per side for papers 50 lbs (75 g/m²) or heavier. At least 50% of the coating weight may be present in a pigment. The coating on the paperbase is believed to provide a smoother surface than plain paper, which contributes to the improved image quality and permanence of the printed image on the print medium 2.

The coating may include a wide variety of conventional coating formulations. For instance, the coating may be an aqueous dispersion ranging from approximately 50% to more than approximately 70% in total solids. Approximately 80% to approximately 90% of a dry formulation weight of the coating may be composed of pigments. Pigments are known in the art and may include china clay, which is available in several grades according to brightness and particle size. Other pigments may include barious sulfate, calcium carbonate, synthetic silicates, titanium dioxide, or plastic pigments. The plastic pigments, such as polystyrene, may be used in combination with other pigments to provide high gloss. A binder may be used to firmly cement particles of the pigment to the paper surface and to each other. When dried, the coating may be a porous structure of pigment particles cemented together at their points of contact rather than a continuous film. The binders may be glue, gums, casein, soya protein, starches, proteins, or synthetics emulsions based on styrene-butadiene, acrylic, or vinylacetate polymers. Representative coating components may be found in the Handbook For Pulp & Paper Technologist, G. A. Smook, Angus Wilde Publications, 2^{nd} Edition (1994), pp. 288, Table 18-3. Calendering may be performed on the coated papers to improve the gloss and smoothness of the paper. Id. at pp. 272-275. The calendered coated paper may include, but is not limited to, Ikono® Gloss 150 Paper, Mega® Matte 150 Paper, Ikono® Matte 200 paper, or Mega Gloss® 200 paper, which are commercially available from Zanders Feinpapiere AG (Finland).

Cast coating may also be used to produce the coated paperbase 6 having the desired gloss and smoothness. In cast coating, a wet coated paper may be pressed into contact with a large-diameter, highly glazed cylinder during the drying phase. The cast coated paperbase may include, but is not limited to, Chromolux® or Zanders Supergloss Paper, which are available from Zanders Feinpapiere AG (Finland).

Preferably, the coated paperbase 6 is a calendered coated paperbase or a cast coated paperbase for optimum gloss and image quality. The coated paperbase 6 may have a Sheffield smoothness lower than approximately 20 and a Sheffield porosity lower than approximately 10. The Hagerty/Sheffield smoothness and porosity of various commercially available paperbases, as measured by the Hagerty Smoothness/Porosity Tester Model #538, is shown in Table 1.

TABLE 1
Sheffield Smoothness/Porosity of Commercially
Available Paperbases

| | | Sheffield | Parker's | |
|---|---|---|---|---|
| | Type of | Smooth- | Smooth- | Sheffield |
| Sample | Paperbase | ness | ness | Porosity |
| HP Multi Purpose | Plain paper | 222.3 | 7.32 | 223.7 |
| RX 100 | Uncoated | 132.7 | 6.47 | 44.0 |
| Classic Crest 004271 | Uncoated | 116.0 | 6.02 | 91.7 |
| Hammermill Color | Uncoated | 72.0 | 4.75 | 89.7 |
| Copy | | | | |
| Westvaco Zirco | Coated | 24.9 | 1.61 | 11 |
| Calendered Cosmo | Coated | 18.8 | 1.54 | 7.67 |
| Paper | | | | |
| Chromolux 200 | Cast-coated | 11.8 | 0.80 | 2.7 |
| Zanders Mega 170 | Coated | 10.6 | 1.64 | 0 |
| Mega Matte 150 | Coated | 8.5 | 1.71 | 0 |
| Ikono Matte 150 | Coated | 8.1 | 1.74 | 0 |
| Zanders Mega 150 | Coated | 7.4 | 1.50 | 0 |
| Zanders Ikono Gloss | Coated | 6.1 | 1.34 | 0 |
| 170 | | | | |
| Zander Super Gloss | Cast-coated | 4.2 | 0.77 | 1.33 |
| Mega Gloss 135 | Coated | 4.0 | 1.29 | 0 |
| Ikono Gloss 200 | Coated | 3.9 | 1.08 | 0 |
| Ikono 150 Gloss | Coated | 3.8 | 1.11 | 0 |

To form the print medium 2, a coating composition of the ink-receiving layer 4 may be formed by combining the components to form a solution or dispersion, as known in the art. The coating composition may be applied to the coated paperbase 6 by a conventional coating technique, such as by roll coating, rod bar coating, air knife coating, spray coating, curtain coating, dip coating, roll coating, or extrusion techniques. The coating composition may then be dried on the coated paperbase 6 to form the ink-receiving layer 4 of the print medium 2.

The ink-receiving layer 4 may be coated on the coated paperbase 6 as a single layer having less than approximately 10 grams per square meter (“GSM”). Preferably, the ink-receiving layer 4 is coated from approximately 3 GSM to approximately 7 GSM and, more preferably, from approximately 4 GSM to approximately 6 GSM. Due to the properties of the coated paperbase 6, such as its porosity, smoothness, and ink absorption rate, a very thin coating of the ink-receiving layer 4 may be used. As previously mentioned, the ink-receiving layer 4 may be a swellable (or polymeric) layer. In comparison to more expensive, photobased print media, images printed on a print medium of the present invention may exhibit better or equal image quality and permanence, such as light fastness and air fastness, and much improved humid bleed and humid color shift. These improved properties may be due, at least in part, to the thin coatweight and the absorptive paperbase used in the present invention.

A conventional inkjet ink and a conventional inkjet printer may be used to print the images on the print medium 2. The inkjet ink may include a dye or pigment as the colorant and other conventional components, such as water-soluble organic solvents, water, buffers, humectants, and surfactants. The printed images have reduced color bleed, humid bleed, and improved lightfastness.

### EXAMPLES

The following examples illustrate that improved image quality and permanence are achieved using the print medium 2 having a thin layer of the ink-receiving layer 4 with the coated paperbase 6. The following examples should not be considered as limitations of the present invention, but should merely teach how to make the best-known print medium based upon current experimental data.

Tables 2, 6, and 7 show formulations of the ink-receiving layer 4 and the coated paperbase 6 used in the print media of the present invention. Tables 3, 4, and 5 show the printing characteristics of these print media compared to commercially available print media, such as HP Premium Plus Glossy Paper, HP Everyday Photo Paper, HP Brochure and Flyer Paper (all available from Hewlett-Packard Co. (Palo Alto, Calif.)), and Jet Print Photo® Professional Paper (available from International Papers (Stamford, Conn.)). HP Premium Plus Glossy Paper is an expensive, high end, photobase paper having a 70 year light stability. HP Everyday Photo Paper is a porous print medium having a paperbase and a silica coating.

Table 8 shows the printing characteristics for the ink-receiving layer formulation applied to the coated paperbases, photobases, and uncoated paperbases listed in Table 7.

### Example 1

### Formulations of Coating Compositions Used in the Print Media

Formulations of each of the coating compositions are shown in Table 2. Each of the coating compositions was produced by mixing the listed components. The amount of each component in each of the coating compositions is listed as parts by weight, unless otherwise indicated. The percent of the surfactant was based on the total weight of the coating compositions. The percent solids of the coating compositions were from approximately 13% to approximately 15% solid, unless indicated. While the order of addition of the components was not critical, improved image quality was observed in formulations having the mordant mixed into the coating composition last.

As shown in Table 2, the coating compositions were applied to Ikono Gloss®, Mega Gloss®, or Mega Matt® coated and offset papers (all products of Zanders Feinpapiere AG) to form the ink-receiving layer 4 of the print media 2. Coating compositions A-T were applied to the coated paperbase 6 with a Mylar rod at approximately 5.5-6.0 GSM and allowed to dry.

TABLE 2
Formulations of the Coating Compositions Used in the Ink-receiving Layer.

| Component (parts) | A | B | C | D | E | F | G | H | I | J | K | L | M | N | O |
|---|---|---|---|---|---|---|---|---|---|---|---|---|---|---|---|
| Mowiol 8-88 | 60 | 60 | 60 | 60 | 60 | 60 | 60 | 60 | 60 | 60 | 60 | 60 | 60 | 60 | 60 |
| Mowiol 15- | 40 | 40 | 40 | 40 | 40 | 40 | 40 | 40 | 40 | 40 | 40 | 40 | 40 | 40 | 40 |
| 79 | | | | | | | | | | | | | | | |
| Ludox ® CL | 10 | 10 | 10 | 10 | 10 | 10 | 10 | 10 | 10 | 10 | 10 | 10 | 10 | 10 | 10 |
| Agefloc | 3 | | | | | | 3 | 3 | 3 | | 3 | 3 | | | |
| WT35-VLV | | | | | | | | | | | | | | | |
| Agefloc CF- | | | | 5 | 5 | 5 | | | | 5 | | | 5 | 5 | |
| 50 | | | | | | | | | | | | | | | |
| Catafix TSF | | | 3.0 | | | | | | | | | | | | |
| Catiofast ® | | | | | | | | | | | | | | | 1 |
| CS | | | | | | | | | | | | | | | |
| Aluminum | | | | | | | | | | | | | | | |
| Triformate | | | | | | | | | | | | | | | |
| Trudot P- | | | | | | | | | | | | | | | |
| 2608 | | | | | | | | | | | | | | | |
| Boric Acid | 1.5 | 1.5 | 1.5 | 2.0 | 2.0 | 2.0 | 2 | 2.0 | 2.0 | 2.5 | 2 | 2 | 2 | 2 | 2 |
| Cartabond | 1.0 | 1.0 | 1.0 | | | | | | | | | | | | |
| TSI | | | | | | | | | | | | | | | |
| Catafix | | 3.0 | | | | | | | | | | | | | |
| 4440 | | | | | | | | | | | | | | | |
| Silwet ® L- | | | | 1.0% | | | 1.0% | | | | 0.5% | 0.5% | 0.5% | 0.5% | |
| 7210 | | | | | | | | | | | | | | | |
| Triton X- | | | | | | | | | | | | | | | |
| 100 | | | | | | | | | | | | | | | |
| Silwet ® L- | 0.5% | 0.5% | 0.5% | | 0.5% | | | 0.5% | | | | | | | |
| 7605 | | | | | | | | | | | | | | | |
| Pluronic | | | | | | 0.5% | | | 0.5% | 0.5% | | | | | 0.5% |
| 25R4 | | | | | | | | | | | | | | | |
| Zonyl FS- | | | | | | | | | | | 0.2% | 0.3% | 0.2% | 0.3% | |
| 300 | | | | | | | | | | | | | | | |
| Paper Base | A | A | A | C | C | A | C | A | D | B | A | A | A | A | B |

A = Mega Gloss 150;
B = Ikono Gloss 150;
C = Mega Gloss 170;
D = Mega Gloss 135;
E = Mega Matt 150

### Example 2

### Print Sample Generation

To determine the printing characteristics of the print media, print samples were generated using a Hewlett-Packard DeskJet® 970 printer. The print samples were printed on print media having the coating compositions described in Example 1. The print mode used for printing a test pattern was based on HP Premium Plus Glossy Paper. For comparison, HP Premium Plus Glossy Paper, HP Everyday Photo Paper, HP Brochure and Flyer Paper, and Jet Print Photo® Professional Paper were also tested.

### Example 3

### Image Quality and Image Permanence Determination and Results

To determine the lighffastness of the print samples described in Example 2, a color block was printed at full density on the print media. Each print medium was exposed to accelerated conditions that simulated light exposure. The light-exposed print medium was compared to a printed sample stored in the dark. The light-exposed print medium was exposed to light having a wavelength of 340 nm and stored at 42° C./35% relative humidity. L*,a*, and b* values were measured, as known in the art, using a commercial calorimeter and standard color measurement procedures.

Any given perceived color can be described using any one of the color spaces, such as CIELAB, as is well known in the art. In the CIELAB color space, a color is defined using three terms L*, a*, and b*. L* defines the lightness of a color, and ranges from zero (black) to 100 (white). The terms a* and b*, together, define the hue. The term a* ranges from a negative number (green) to a positive number (red). The term b* ranges from a negative number (blue) to a positive number (yellow). L*,a*, and b* values were measured, as known in the art, using a commercial calorimeter and standard color measurement procedures. These values were used to calculate the volume of space that a specific dye set can produce. The larger the volume, the more colors the dye set is capable of producing. A color gamut value of greater than approximately 400,000 is desired.

Black density, expressed as K_{od}, was measured by an X-Rite 938 SpectroDensitometer. A K_{od} value greater than approximately 2.1 is desired.

The gloss/haze uniformity were determined with a BYK GB-4535 gloss/haze meter by measuring the 20 degree gloss/haze of KCM squares at 50 and 100% saturation in comparison to the unimaged area. The numbers are compiled and given a rating of good, average, or poor. Mottling is the unevenness of the image after the print was dried for 24 hours. The rating is determined by visual inspection.

Humid bleed was determined by equilibrating the print media and the printer in a 30° C./80% relative humidity (“RH”) environmental chamber for 2 hours prior to imaging. A test pattern having 40 mils wide CMYRGBK strips on top of 100% CMYRGBK color blocks was printed. The samples were allowed to stand for four days at 35° C./80% RH and then were removed and stabilized at 23° C./50% RH. The Eyegore image analysis system was used to measure the increase of width of each color in mils or microns. The worst color in humid bleed was reported in delta in mils or microns before and after the test.

To determine the humid color shift, the test conditions and sample preparation were the same as previously described for the humid bleed test. A 10-step neutral ramp was used to measure the humid color shift. The L*a*b* values of the original and humidified samples were measured. ΔE₉₄ (or ΔE₁₉₉₄) was used to calculate the humid color shift and the average number of the ten ΔE₉₄ was reported as the humid color shift.

Color gamut (CIELAB volumes), gloss/haze uniformity, and K_{od} values for images printed on the print media 2 described in Example 1 are shown in Table 3. Humid bleed and humid color shift values, are shown in Table 4.

TABLE 3
Image Quality for the Print Media Described in Table 2.

| | Gamut CIELab | | Gloss/Haze |
|---|---|---|---|
| Sample | Volumes | K_{od} | uniformity |
| HP Premium Plus Glossy | 410,000-430,000 | 2.13-2.24 | Poor to |
| Paper (Comparison) | | | average |
| HP Everyday Photo Paper | 380,000-390,000 | 1.83 | Good |
| (Comparison) | | | |
| Jet Print PRO (Comparison) | 386,724 | 1.73 | Good |
| HP Brochure and Flyer | 323,103 | 1.72 | Average |
| Paper (Comparison) | | | |
| A | 439,968 | 2.04 | Good |
| B | 471,740 | 2.38 | Good |
| C | 456,228 | 2.4 | Good |
| D | 446,709 | 2.5 | Good |
| F | 480,738 | 2.65 | Good |
| G | 456,597 | 2.56 | Good |
| I | 475,248 | 2.61 | Good |
| J | 500,946 | 2.71 | Good |
| K | 456,949 | 2.43 | Good |
| L | 456,686 | 2.43 | Good |
| M | 450031 | 2.37 | Good |
| N | 456752 | 2.37 | Good |
| S | 482,910 | 2.39 | Good |
| T | 473,000 | 2.67 | Good |

TABLE 4
Image Permanence for the Print Media Described in Table 2.

| | Humid bleed | | |
|---|---|---|---|
| | (μ) | Humid bleed | Humid Color |
| Sample | worst color | (μ) k halo | Shift (ΔE94) |
| HP Premium | 251 | 155 | 4.8 |
| Plus Glossy | | | |
| Paper | | | |
| (Comparison) | | | |
| HP Everyday | 455 | 323 | 5.1 |
| Photo Paper | | | |
| (Comparison) | | | |
| Jet Print PRO | 762 | 384 | 4.4 |
| (Comparison) | | | |
| HP Brochure | 488 | 424 | 3 |
| and Flyer Paper | | | |
| (Comparison) | | | |
| A | 165 | 84 | 2.9 |
| B | 152 | 79 | 2.3 |
| C | 165 | 74 | 1.6 |
| D | 150 | 53 | 3.8 |
| F | 145 | 91 | 2.8 |
| G | 145 | 76 | 3.2 |
| I | 124 | 76 | 3.1 |
| L | 157 | 66 | 4.2 |
| M | 165 | 56 | 3.3 |
| N | 165 | 58 | 3.1 |
| S | 191 | 91 | 3 |
| T | 150 | 71 | 3.6 |

Table 3 shows that the coating compositions in combination with the coated paperbases 6 provided print media 2 having superior image quality in comparison to the commercially available print media. Table 4 shows that the coating compositions in combination with the coated paperbases 6 provided print media 2 with much improved humid bleed and humid color shift.

### Example 4

### Lightfastness Determination and Results

Lighffastness was measured using an ATLAS HPUV™ Indoor Actinic Exposure System, from ATLAS Material Testing Technology LLC, Chicago, Ill., USA. The results of the lightfastness tests are shown in Table 5. The “Years to Failure” was measured by extrapolating the optical density changes to the failure point and the measurement of optical density change was based on a 5 year simulation time. The simulation was based on the assumption that the dose of light exposure was 400 lux per hour and the exposure time was 12 hours per day. Therefore, the total light exposure dose for 5 years was 8760 lux. The lighffastness data is reported as the number of years necessary to exceed a 30% loss of optical density for a square with a starting optical density of 0.5.

TABLE 5
Lightfastness Data for the Print Media Described in Table 2.

| Sample | Failure Mode | Years to Failure |
|---|---|---|
| HP Premium Plus | Pure Cyan | 8.6 |
| Glossy Paper | | |
| (Comparison) | | |
| HP Everyday Photo | Magenta in Neutral | 1.4 |
| Paper (Comparison) | | |
| Jet Print PRO | Magenta in Neutral | 1.9 |
| (Comparison) | | |
| HP Brochure and Flyer | Magenta in Neutral | 1.7 |
| Paper (Comparison) | | |
| D | D(B) in Dmin | 11.4 |
| E | D(B) in Dmin | 12.5 |
| F | Pure Cyan | 9.2 |
| G | Magenta in Neutral | 10.3 |
| J | Magenta in Neutral | 9.3 |
| K | Cyan in Neutral | 11.4 |
| M | Pure Cyan | 9 |
| N | Pure Cyan | 12.2 |
| O | Neutral Dhue (RG) | 10.2 |
| P | Neutral Dhue (RB) | 8 |
| Q | Neutral Dhue (RB) | 8.1 |
| R | D(B) in Dmin | 15.6 |

As shown in Table 5, the print media 2 utilizing the coating compositions described in Example 1 on the coated paperbases 6 exhibited comparable or higher lighffastness compared to the much higher cost, photobased HP Premium Plus Glossy Paper. The print media 2 also exhibited higher lighffastness than the commercially available non-photobased products, such as the HP Everyday Photo Paper, the HP Brochure and Flyer Paper, and the Jet Print Photo® Professional Paper.

### Example 5

### Comparison of Paperbase Types on the Image Quality of the Print Media

To demonstrate the advantages of using the coated paperbase 6 or cast-coated paperbase 6, formulation M, as described in Table 6, was coated on some of the representative paperbases described in Table 1.

Formulation AA was applied at 5.5 GSM to the coated paperbases, photobases, and uncoated paperbases listed in Table 7.

Table 6: Formulation of a Coating Composition Applied to Coated Paperbases, Photobases, and Uncoated Paperbases.

| Component (parts) | Formulation AA |
|---|---|
| Mowiol 8-88 | 60 |
| Mowiol 15-79 | 40 |
| Agefloc CF 50-P | 2 |
| Boric Acid | 0.5 |
| Ludox ® CL | 10 |
| Silwet ® L-7605 | 0.5 |
| Pluronic 25R4 | |

TABLE 7
Types of Coated Paperbases, Photobases, and Uncoated Paperbases.

| I.D. | Name | Type | Manufacturer |
|---|---|---|---|
| Base ID 1 | Ikono ® Gloss 150 | Coated paperbase | Zanders |
| | Paper | | |
| Base ID 2 | Mega ® Matte 150 | Coated paperbase | Zanders |
| Base ID 3 | Zanders supergloss | Coated paperbase | Zanders |
| | Paper | | |
| Base ID 4 | 6 mm gel subbed | Photobase | Schoeller |
| | photo | | |
| Base ID 5 | 9 mm gel subbed | Photobase | Schoeller |
| | photo | | |
| Base ID 6 | Westvaco RX-700 | Uncoated | Westvaco |
| Base ID 7 | Hammermill ® Color | Uncoated | International |
| | Copy | | Paper |
| Base ID 8 | Classic Crest ® | Uncoated | Georgia Pacific |
| Base ID 9 | HP Multipurpose | Uncoated | HP |

The print media produced were imaged with a HP Deskjet 970 printer and their image quality and humid permanence were evaluated as previously described. The image quality and humid permanence results are shown in Table 8.

TABLE 8
Image Quality and Permanence Data for Formulation AA

| | | | | Humid bleed | | |
|---|---|---|---|---|---|---|
| | | | | (mils) | Humid bleed | Humid Color |
| | Gamut CIELab | Gloss/Haze | | worst | (mils) k | Shift |
| Paper Base | Volumes | uniformity | K_{od} | color | halo | (ΔE₉₄) |
| Base ID 1 | 442451 | Average | 2.4 | 6.4 | 4.2 | 3.8 |
| Base ID 2 | 443591 | Good | 2.5 | 6.5 | 4.1 | 3.3 |
| Base ID 3 | 448817 | Average | 2.6 | 10.1 | 7.1 | 4 |
| Base ID 4 | 440748 | Poor | 2.4 | 31 | 21.6 | 5.3 |
| (Comparison) | | | | | | |
| Base ID 5 | 433160 | Poor | 2.4 | 31.4 | 20.7 | 5.2 |
| (Comparison) | | | | | | |
| Base ID 6 | 357802 | Average | 1.8 | 5 | 4 | 2.8 |
| (Comparison) | | | | | | |
| Base ID 7 | 319081 | Average | 1.6 | 5.5 | 4.3 | 3.3 |
| (Comparison) | | | | | | |
| Base ID 8 | 305201 | Average | 1.6 | 5.1 | 4 | 3.1 |
| (Comparison) | | | | | | |
| Base ID 9 | 133823 | Average | 1 | 5 | 4.3 | 6.2 |
| (Comparison) | | | | | | |

As shown in Table 8, the coated paperbases exhibited the best overall performance in gamut, gloss uniformity, K_{od}, and humid fastness. The print media that used a coated paperbase (Base ID 1-3) instead of a photobase (Base ID 4-5) showed improved humid bleed and humid color shift. The print media that used a coated paperbase (Base ID 1-3) showed best overall image quality and humid fastness.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope thereof as defined by the following appended claims.

1. A print medium comprising:
an ink-receiving layer and a coated paperbase, the ink-receiving layer present on the coated paperbase at less than approximately 10 grams per square meter and the coated paperbase having a Sheffield smoothness less than approximately 20 and a Sheffield porosity less than approximately 10.

2. The print medium of claim 1, wherein the ink-receiving layer is present from approximately 3 grams per square meter to approximately 7 grams per square meter.

3. The print medium of claim 1, wherein the ink-receiving layer comprises at least one water-soluble polymer, a cross-linking agent, a mordant, inorganic particles, and at least one surfactant.

4. The print medium of claim 3, wherein the at least one water-soluble polymer comprises at least one polyvinyl alcohol; the cross-linking agent comprises boric acid; the mordant comprises at least one of diallyldimethyl-ammonium chloride, a cationic latex, or aluminum triformate; and the inorganic particles comprise cationic, superfine colloidal silica.

5. The print medium of claim 1, wherein the ink-receiving layer is present from approximately 4 grams per square meter to approximately 6 grams per square meter.

6. The print medium of claim 1, wherein the at least one surfactant comprises at least one nonionic, organosilicone surfactant.

7. The print medium of claim 1, wherein the at least one surfactant is at least one polysiloxane-polyethylene oxide compound or at least one polysiloxane-polyethylene oxide-polypropylene oxide compound.

8. The print medium of claim 1, wherein the coated paperbase comprises a coated paper, a cast-coated paper, or a commercial offset paper.

9. A method of forming a print medium having improved image quality and permanence, comprising:
providing a coated paperbase; and
applying an ink-receiving layer to the coated paperbase at less than approximately 10 grams per square meter, the coated paperbase having a Sheffield smoothness less than approximately 20 and a Sheffield porosity less than approximately 10.

10. The method of claim 9, wherein providing a coated paperbase comprises providing the coated paperbase selected from the group consisting of a coated paper, a cast-coated paper, and a commercial offset paper.

11. The method of claim 9, wherein applying an ink-receiving layer to the coated paperbase at less than approximately 10 grams per square meter comprises applying the ink-receiving layer from approximately 3 grams per square meter to approximately 7 grams per square meter.

12. The method of claim 9, wherein applying an ink-receiving layer to the coated paperbase at less than approximately 10 grams per square meter comprises applying a coating composition comprising at least one water-soluble polymer, a cross-linking agent, a mordant, inorganic particles, and at least one surfactant.

13. The method of claim 12, wherein applying an ink-receiving layer to the coated paperbase at less than approximately 10 grams per square meter comprises applying a coating composition comprising at least one polyvinyl alcohol; boric acid; at least one of diallyldimethylammonium chloride, a cationic latex, or aluminum triformate; cationic, superfine colloidal silica; and at least one polysiloxane-polyethylene oxide compound.

14. The method of claim 12, wherein applying an ink-receiving layer to the coated paperbase at less than approximately 10 grams per square meter comprises applying the ink-receiving layer from approximately 4 grams per square meter to approximately 6 grams per square meter.

15. The method of claim 9, wherein applying an ink-receiving layer to the coated paperbase at less than approximately 10 grams per square meter comprises coating the ink-receiving layer on the coated paperbase at less than approximately 10 grams per square meter.

16. A method of printing an image having improved image quality and permanence, comprising:
providing a print medium comprising a coated paperbase and an ink-receiving layer present on the coated paperbase at less than approximately 10 grams per square meter, the coated paperbase having a Sheffield smoothness less than approximately 20 and a Sheffield porosity less than approximately 10; and
printing the image on the print medium.

17. The method of claim 16, wherein providing a print medium comprising a coated paperbase and an ink-receiving layer present on the coated paperbase at less than approximately 10 grams per square meter comprises providing the coated paperbase selected from the group consisting of a coated paper, a cast-coated paper, and a commercial offset paper.

18. The method of claim 16, wherein providing a print medium comprising a coated paperbase and an ink-receiving layer present on the coated paperbase at less than approximately 10 grams per square meter comprises providing the ink-receiving layer on the coated paperbase from approximately 3 grams per square meter to approximately 7 grams per square meter.

19. The method of claim 16, wherein providing a print medium comprising a coated paperbase and an ink-receiving layer present on the coated paperbase at less than approximately 10 grams per square meter comprises providing the ink-receiving layer comprising at least one water-soluble polymer, a cross-linking agent, a mordant, inorganic particles, and at least one surfactant.

20. The method of claim 16, wherein providing a print medium comprising a coated paperbase and an ink-receiving layer present on the coated paperbase at less than approximately 10 grams per square meter comprises providing the ink-receiving layer comprising at least one polyvinyl alcohol; boric acid; at least one of diallyldimethylammonium chloride, a cationic latex, or aluminum triformate; cationic, superfine colloidal silica; and at least one polysiloxane-polyethylene oxide compound.
